(19) United States
(12) Patent Application Publication
(10) Pub. No.: US 2025/0323990 A1
(43) Pub. Date: Oct. 16, 2025

(54) DUAL-MODE MOBILE PHONE HOLDER AND MOBILE PHONE EXPANSION BRACKET

(71) Applicant: Shenzhen Leqi Innovation Co., Ltd., Shenzhen (CN)

(72) Inventors: Wei TANG, Shenzhen (CN); Tao JIANG, Shenzhen (CN); Nan QI, Shenzhen (CN); Feng QIN, Shenzhen (CN)

(73) Assignee: Shenzhen Leqi Innovation Co., Ltd., Shenzhen (CN)

(21) Appl. No.: 19/015,678

(22) Filed: Jan. 10, 2025

(30) Foreign Application Priority Data
Apr. 15, 2024 (CN) 202420782673.6

(51) Int. Cl. H04M 1/04

(52) U.S. Cl. CPC H04M 1/04

(57) ABSTRACT

The invention discloses a dual-mode mobile phone holder, comprising: a housing; a clamping assembly, comprising two clamping plates oppositely arranged on the housing, at least one clamping plate slidable with respect to the housing to clamp or release a mobile phone; and a magnetic attraction assembly, arranged on the housing and located between the two clamping plates. The clamping assembly and the magnetic attraction assembly are arranged on the housing, and the clamping attraction assembly comprises the two clamping plates slidably connected to the housing, such that users can selectively use the clamping plates to clamp a mobile phone or use the magnetic attraction assembly to attract a mobile phone, thus expanding the application range of the mobile phone holder and satisfying different usage requirements of users. In addition, the invention further discloses a mobile phone expansion bracket.

### FIELD

The invention relates to the field of phone holders, in particular to a dual-mode mobile phone holder and a mobile phone expansion bracket.

### BACKGROUND

With the development of society, there is a sharp increase in the use of smartphones. The smartphones are not only used as communication tools, but also can be used for online transaction, shopping, traffic navigation, positioning, and audio and video playing, satisfying requirements of users in different occasions because of their diversity and multiple functions. For easing use of mobile phones, mobile phone holders appear to free users' hands.

Existing mobile phone holders are either elastic mobile phone holders or magnetic mobile phone holders. The elastic mobile phone holders clamp mobile phones or tablet computers of different sizes by means of elasticity, and the magnetic mobile phone holders clamp mobile phones by magnetic heads and magnetic structures in the mobile phones. However, with the diversification of mobile phone types, more and more users possess more than one mobile phone, and mobile phone holders holding mobile phones in single mode can no longer satisfy users' requirements.

### SUMMARY

The main objective of the invention is to provide a dual-mode mobile phone holder to solve the problem that existing mobile phone holders hold mobile phones in single mode.

According to one aspect of the present invention, a dual-mode mobile phone holder, comprises a housing; a clamping assembly, comprising two clamping plates oppositely arranged on the housing, at least one of the clamping plates being slidable with respect to the housing to clamp or release a mobile phone; and a magnetic attraction assembly, arranged on the housing and located between the two clamping plates.

wherein the housing comprises a main body, and the clamping assembly further comprises a first spring, one end of which is connected to the main body and the other end is connected to at least one of the clamping plates.

further comprising a switching component used for switching between a magnetic attraction mode and a clamping mode of the dual-mode mobile phone holder, wherein in the magnetic attraction mode, the switching component abuts against the clamping plates to keep the two clamping plates away from each other; and in the clamping mode, the switching component keeps away from the clamping plates, and the first spring drives at least one of the clamping plates to allow the two clamping plates to draw close to each other.

wherein the main body defines a first sliding groove, and the clamping plates are slidably along the first sliding groove; and each of the clamping plates comprises a clamping portion and a sliding portion that is connected to the clamping portion and forms an included angle with the clamping portion, and the sliding portion is slidable along the first sliding groove.

wherein an elongated hole is defined in each of the sliding portions and extends in a length direction of the corresponding sliding portion, stop pillars are arranged on the main body, and the elongated hole is disposed around the corresponding stop pillar.

wherein each of the sliding portion is provided with a hooking portion connected to the corresponding first spring.

wherein the main body defines a second sliding groove, the second sliding groove intersects with the first sliding groove, an opening of the second sliding groove is exposed on the main body; the switching component comprises a pressing portion and a limit portion connected to the pressing portion, the pressing portion is slidable along the second sliding groove, and the limit portion is provided with protrusions used for abutting against the clamping plates.

wherein a stop end of the second sliding groove is provided with a positioning slot, the dual-mode mobile phone holder further comprises a second spring located in the positioning slot, and the limit portion abuts against the second spring.

wherein the magnetic attraction assembly comprises a magnetic component and a buffer component, the magnetic component is connected to the main body and partially covers the sliding portions, and the buffer component is arranged around the magnetic component.

According to another aspect of the present invention, a mobile phone expansion bracket, comprising an expansion frame and the dual-mode mobile phone holder, wherein the dual-mode mobile phone is provided with mounting plates, and the mounting plates are detachably connected to the expansion frame.

According to another aspect of the present invention, a dual-mode mobile phone holder, comprises a housing; a clamping assembly, comprising two clamping plates oppositely disposed on the housing, at least one of the clamping plates being slidable with respect to the housing to adjust a relative distance between the clamping plates for clamping or releasing a mobile phone; and a magnetic attraction assembly, arranged on the housing and located between the clamping plates for holding a mobile phone by magnetic attraction between the magnetic attraction assembly and the mobile phone.

The dual-mode mobile phone holder comprises a switching component used for switching between a magnetic attraction mode and a clamping mode, wherein the switching component abuts against the clamping plates to increase the relative distance between the clamping plates for disabling holding a mobile phone between the clamping plates in the magnetic attraction mode; and the switching component deviates from the clamping plates for enabling holding a mobile phone between the clamping plates in the clamping mode.

The housing comprises a main body, the main body defines a first sliding groove and a second sliding groove intersecting with the first sliding groove, at least one of the clamping plates is slidably arranged in the first sliding groove, the switching component comprises a pressing portion and a limit portion connected to the pressing portion, the pressing portion is slidable along the second sliding groove, and the limit portion is provided with protrusions for abutting against the clamping plates.

One end of the pressing portion protrudes from the main body via an opening of the second sliding groove, for manipulating the pressing portion to drive the limit portion to slide in the second sliding groove, the limit portion is arranged between the clamping plates, and the protrusions are arranged at two ends of the limit portion.

A positioning slot is defined at a stop end of the second sliding groove opposite to the opening, a second spring is located in the positioning slot, one end of the second spring abuts against the positioning slot, and the other end of the second spring abuts against a side face of the limit portion for elastically connected the limit portion and the housing.

The magnetic attraction assembly comprises a magnetic component for providing a magnetic force to attract a mobile phone and a buffer component, the magnetic component is a magnet or an electromagnetic coil, and the buffer component covers the magnetic component to prevent the magnetic component against direct contact with a mobile phone.

The magnetic attraction assembly comprises a second magnetic component arranged on a side of the housing facing away from the magnetic component.

The housing comprises a main body, the main body defines a first sliding groove, each clamping plate comprises a clamping portion vertically protruding from a top surface of the main body and a sliding portion connected to the clamping portion, the sliding portion is slidable along the first sliding groove, and the depth of the first sliding groove is equal to the thickness of the sliding portion.

An elongated hole is defined in each of the sliding portions extending in a length direction of the corresponding sliding portion, stop pillars are provided on the main body, the elongated hole is disposed around the corresponding stop pillar, the elongated hole is slidable with respect to the corresponding stop pillar so as to limit a moving direction of the corresponding clamping plate.

The clamping assembly further comprises at least one first spring, the sliding portion is provided with a hooking portion, one end of the first spring is connected to the main body, and the other end of the first spring is connected to the hooking portion.

In the dual-mode mobile phone holder and the mobile phone expansion bracket according to exemplary embodiments of the present invention, the clamping assembly and the magnetic assembly are arranged on the housing, and the clamping assembly comprises two clamping plates slidably connected to the housing, such that users can selectively use the clamping plates to clamp a mobile phone or use the magnetic assembly to attract a mobile phone, thus expanding the application of the mobile phone holder and satisfying different usage requirements of users.

### BRIEF DESCRIPTION OF THE DRAWINGS

FIG. 1 is a schematic structural view of one embodiment of a dual-mode mobile phone holder according to the invention;

FIG. 2 is a right view of some components of the dual-mode mobile phone holder according to the invention;

FIG. 3 is a sectional view of the embodiment along A-A in FIG. 2;

FIG. 4 is a schematic structural view of some components of the dual-mode mobile phone holder according to the invention;

FIG. 5 is a schematic structural view of a switching component of the dual-mode mobile phone holder according to the invention;

FIG. 6 is a schematic structural view of a clamping plate of the dual-mode mobile phone holder according to the invention;

FIG. 7 is a schematic structural view of a housing of the dual-mode mobile phone holder according to the invention;

FIG. 8 is a top view of a magnetic attraction assembly of the dual-mode mobile phone holder according to the invention;

FIG. 9 is a sectional view of the magnetic attraction assembly along B-B in FIG. 8;

FIG. 10 is a bottom view of the magnetic attraction assembly in FIG. 8;

FIG. 11 is a schematic structural view of a cover plate of the dual-mode mobile phone holder according to the invention;

FIG. 12 is a schematic structural view of one embodiment of a mobile phone expansion bracket according to the invention.

### REFERENCE SIGNS

100, housing; 110, main body; 111, first sliding groove; 112, stop pillar; 113, second sliding groove; 113a, positioning slot; 120, second spring; 130, mounting plate; 131, threaded hole; 200, clamping assembly; 210, clamping plate; 211, sliding portion; 211a, elongated hole; 211b, hooking portion; 212, clamping portion; 220, first spring; 300, magnetic attraction assembly; 310, magnetic component; 320, buffer component; 330, shell; 340, lubricating sheet; 350, second magnetic component; 400, switching component; 410, limit portion; 411, protrusion; 420, pressing portion; 500, cover plate; 510, indentation; 600, expansion frame.

### DESCRIPTION OF THE EMBODIMENTS

The technical solutions in the embodiments of the invention will be clearly and completely described below in conjunction with accompanying drawings of these embodiments. Obviously, the embodiments in the following description are merely illustrative ones and are not all possible ones of the invention. All other embodiments obtained by those ordinarily skilled in the art according to the following ones without creative labor should also fall within the protection scope of the invention.

It should be noted that all directional indications, such as “upper”, “lower”, “left”, “right”, “front” and “back”, in the embodiments of the invention are merely used to explain relative positional relations and motions between components in a specific attitude (as shown below), and once the specific attitude changes, these directional indications will change accordingly.

It should also be noted that when one component is referred to as being “fixed to” or “arranged on” the other component, it may be “fixed to” or “arranged on” the other component directly or by means of an intermediate component. When one component is referred to as being “connect to” the other component, it may be connected to the other component directly or by means of an intermediate component.

In addition, descriptions such as “first” and “second” involved in the invention are merely for a purpose of description, and should not be construed as indicating or implying relative importance or implicitly indicating the number of technical features referred to. Therefore, a feature defined by “first” or “second” may explicitly or implicitly indicate the inclusion of at least one said feature. In addition, the technical solutions in the embodiments may be combined as long as it can be implemented by those skilled in the art. In a case where a combination of the technical solutions is contradictory or cannot be implemented, the combination should be construed as non-existent and will not fall within the protection scope of the invention.

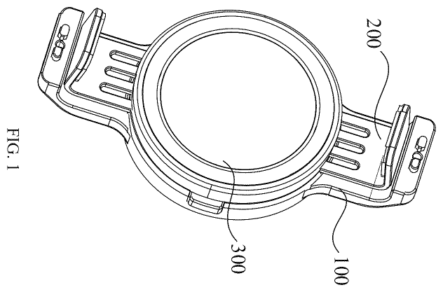

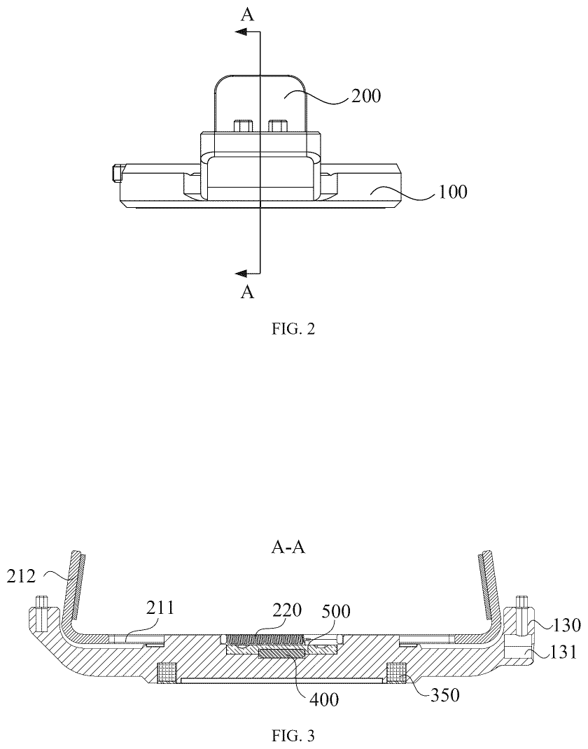

The invention provides a dual-mode mobile phone holder. Referring to FIGS. 1-4, the dual-mode mobile phone holder comprises:
a housing 100;
a clamping assembly 200, comprising two clamping plates 210 oppositely arranged on the housing 100, at least one of the clamping plates 210 slidable with respect to the housing 100 to clamp or release a mobile phone; and
a magnetic attraction assembly 300, arranged on the housing 100 and located between the two clamping plates 210.

In use, the dual-mode mobile phone holder can clamp a mobile phone in a suitable mode according to users' requirements and the type of the mobile phone. For example, if the mobile phone has magnetic attraction function, the two clamping plates 210 can be pulled apart completely, and the mobile phone is held only by the magnetic attraction assembly 300. If the mobile phone does not have magnetic attraction function, the distance between the clamping plate 210 is adjusted according to the size of the mobile phone, and the mobile phone is clamped between the clamping plates 210. It can be understood that even if the mobile phone has magnetic attraction function, the mobile phone can also be clamped by the clamping plates 210 for being held, and in this case, the magnetic attraction assembly 300 also attracts the mobile phone, such that the mobile phone can be held more firmly for preventing from shaking or falling off in use.

The housing 100 is a structure used for supporting the clamping assembly 200 and the magnetic attraction assembly 300, and may be formed integrally or by multiple components assembled together. The housing 100 is generally made from plastic, for low cost and ease with machining. Otherwise, the housing 100 may be made from metal, silicone or a composite material. The invention has no limitation in this aspect.

The clamping assembly 200 comprises two clamping plates 210 arranged opposite to each other, and at least one of the clamping plates 210 is slidably connected to the housing 100, such that the distance between the clamping plates 210 can be adjusted to clamp different types of mobile phones. The clamping assembly 200 is slidably connected to the housing 100 in various ways. For example, a sliding rail is arranged on the housing 100, a sliding block is correspondingly arranged on at least one of the clamping plates 210, and the sliding block is slidably connected to the sliding rail to drive at least one of the clamping plates 210 to slide on the housing 100. Otherwise, a receiving cavity is defined in the housing 100, one end of the clamping plate 210 is able to slide in the receiving cavity, and the other end of the clamping plate 210 is used for clamping a mobile phone. The shape of the clamping plates 210 may be set in accordance with requirement as long as a mobile phone can be held by the clamping plates 210.

The magnetic attraction assembly 300 is a common magnetic structure on the market. In this embodiment, the magnetic attraction assembly 300 is circular as a whole and is partially coaxial with a middle circular portion of the housing 100, such that the mobile phone holder is more aesthetic, has a stronger attraction, and occupies a smaller space.

In the invention, the clamping assembly 200 and the magnetic attraction assembly 300 are arranged on the housing 100, the clamping assembly 200 comprising the two clamping plates 210 slidably connected to the housing 100, such that users can selectively use the clamping plates 210 to clamp a mobile phone or use the magnetic attraction assembly 300 to attract a mobile phone, thus expanding the application of the mobile phone holder and satisfying different requirements of users.

As shown in FIGS. 1-4, in some embodiments, the housing 100 comprises a main body 110, the clamping assembly 200 further comprises at least one first spring 220, one end of the first spring 220 is connected to the main body 110, and the other end of the first spring 220 is connected to at least one of the clamping plates 210.

An elastic force provided by the first spring 220 can drive at least one of the clamping plates 210 to slide with respect to the housing 100, such that a mobile phone can be clamped by the clamping plates 210. Specifically, when the first spring 220 is in a contracted state, a relative distance between the two clamping plates 210 is minimized. As a mobile phone is placed between the clamping plates 210, the distance between the clamping plates 210 is increased, and the first spring 220 is stretched, such that the mobile phone is clamped.

In a preferred embodiment, a shaft or sleeve component may be arranged to guide and position the first spring 220 to keep an axial direction of the first spring 220 the same as the moving direction of the clamping plates 210 and prevent accidental deformation of the first spring 220, thus improving the stability of the first spring 220 and extending the service life of the first spring 220.

In some embodiments, the dual-mode mobile phone holder further comprises a switching component 400 used for switching between a magnetic attraction mode and a clamping mode of the dual-mode mobile phone holder. In the magnetic attraction mode, the switching component 400 abuts against the clamping plates 210 to keep the two clamping plates 210 away from each other. That is, the minimum relative distance between the clamping plates 210 is increased for disabling holding a mobile phone between the clamping plates. In the clamping mode, the switching component 400 keeps away from the clamping plates 210, and the first spring 220 drives at least one of the clamping plates 210 for allowing the two clamping plates 210 to get closer to each other. That is, the switching component 400 deviates from the clamping plates 210, and the relative distance between the clamping plates 210 can be minimized for enabling holding a mobile phone between the clamping plates 210.

The switching component 400 is generally arranged between the clamping plates 210. For example, a groove may be defined between the two clamping plates 210, and the switching component 400 is arranged in the groove and can be pressed to slide up and down in the groove. When a user needs to fix a mobile phone only by the magnetic attraction, the switching component 400 is manipulated to eject from the groove and abut against the clamping plates 210 to limit the minimum relative distance between the clamping plates 210. When a user needs to fix a mobile phone by the clamping plates 210, the switching component 400 is pressed to be completely received in the groove, and at this moment, the clamping plates 210 get closer to each other under the action of the first spring 220 to clamp the mobile phone.

Through the switching component 400, users can freely switch the current mode in which a mobile phone is held, such that different types of mobile phones can be held, and usage experience is greatly improved.

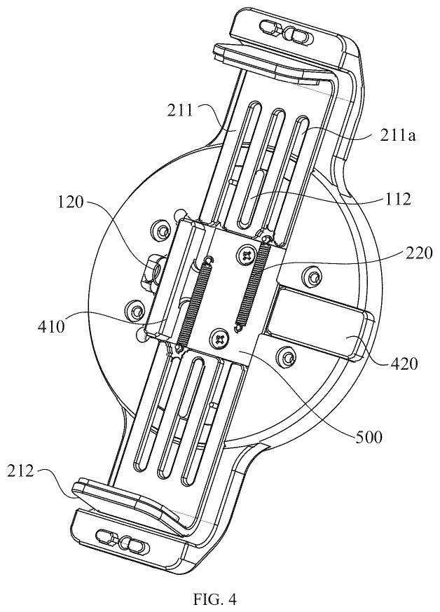

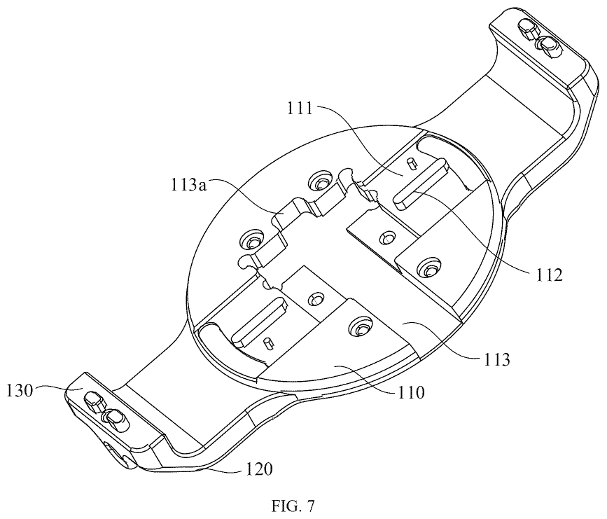

As shown in FIGS. 4 and 7, in some embodiments, the main body 110 defines a first sliding groove 111, and the clamping plates 210 are slidably arranged in the first sliding groove 111; each clamping plate 210 comprises a clamping portion 212 vertically protruding from a top surface of the main body 110 and a sliding portion 211 that is connected to the clamping portion 212 and forms an included angle with the sliding portion 211, and the sliding portion 211 is slidable along the first sliding groove 111.

The sliding portion 211 is generally parallel to a surface of the main body 110 to facilitate driving the clamping portion 212 to slide on the housing 100; the clamping portion 212, as a component for providing a pressure to clamp a mobile phone, generally forms an included angle with the sliding portion 211 to firmly clamp the mobile phone. Preferably, an anti-slip mat may be arranged on a side of the clamping portion 212 for clamping a mobile phone, to improve the friction between the clamping portion 212 and the mobile phone, so as to prevent the mobile phone from falling off accidentally. The anti-slip mat is generally made from a material with a large friction coefficient, such as rubber, silicone or fiber materials. Otherwise, the anti-slip mat is a structure with an anti-slip surface, for example, providing grains or patterns on the surface of the anti-slip mat, such that a good anti-slip effect can also be fulfilled. The anti-slip mat may be fixed to the clamping portion 212 by bonding, welding, magnetic attraction or bolts. This embodiment has no limitation in this aspect.

The sliding portion 211 and the clamping portion 212 may be formed integrally or fixed together by welding, bonding, or detachable connection such as snap fit or threaded connection, such that users can remove, repair or replace a damaged part thereof easily. Further, a joint between the sliding portion 211 and the clamping portion 212 is chamfered, such that a mobile phone is less likely to be scratched, the aesthetics is improved, stress concentration at the joint is reduced, and the service life of the clamping plates 210 are extended.

The main body 110 is further provided with the first sliding groove 111, and the sliding portion 211 is fit in the first sliding groove 111, such that the sliding portion 211 can smoothly slide on the main body 110 without deflection. Preferably, the depth of the first sliding groove 111 is equal to the thickness of the sliding portion 211, for enhance the appearance of the dual-mode mobile phone holder and facilitating mounting of the magnetic attraction assembly.

As shown in FIGS. 4, 6 and 7, in some embodiments, an elongated hole 211a is defined in each of the sliding portions 211 and extends in a length direction of the corresponding sliding portion 211, stop pillars 112 are provided on the main body 110, and the elongated hole 211a is disposed around the corresponding stop pillar 112.

The elongated holes 211a formed in the sliding portions 211 work together with the stop pillars 112 on the main body 110 to prevent the clamping plates 210 against deflection during moving, such that a length direction of the elongated holes 211a is the same as the length direction of the sliding portions 211. In specific use, at least one of the clamping plates 210 slides on the housing 100 under the action of the first spring, and the elongated hole 211a is slidable with respect to the corresponding stop pillar 112, such that the moving direction of the corresponding clamping plate 210 is limited. It can be understood that multiple elongated holes 211a may be defined in the sliding portion 211 to reduce the weight of the clamping plates 210; and multiple elongated holes 211a work together with multiple stop pillars 1123 to prevent the clamping plate 210 against deflection in the moving process. Further, at least one stop pillar 112 fits with the elongated hole 211a in size. That is, the outer diameter of the at least one stop pillar 112 is slightly smaller than the inner diameter of the corresponding elongated hole 211a, such that the moving direction of the clamping plate 210 is greatly limited.

As shown in FIG. 6, in some embodiments, the sliding portion 211 is provided with a hooking portion 211b connected to the first spring 220. The hooking portion 211b is a long and straight cylinder, and a structure matched with the hooking portion 211b, such as a hook or ring, is arranged at an end of the first spring 220. The hook or ring is disposed around the hooking portion 211 to connect the first spring 220 to the clamping plate 210, such that the clamping plate 210 can slide on the housing 100.

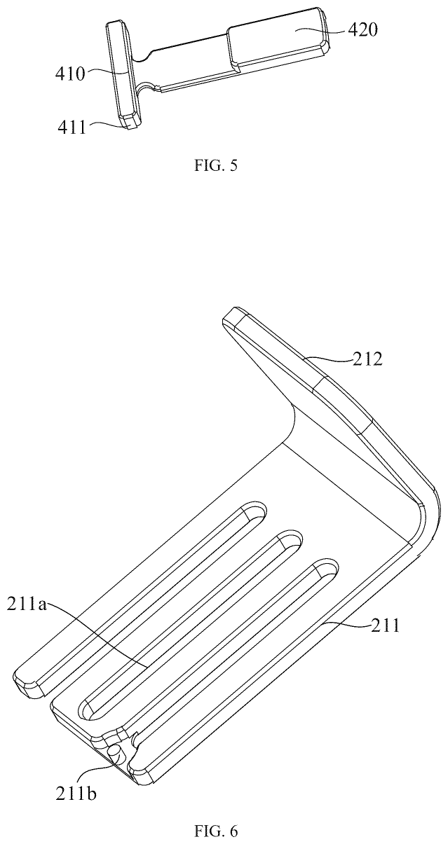

As shown in FIGS. 4-7, in some embodiments, the main body 110 further defines a second sliding groove 113, the second sliding groove 113 intersects with the first sliding groove 111, and an opening of the second sliding groove 113 is exposed on the main body 110. The dual-mode mobile phone holder further comprises the switching component 400, the switching component 400 comprises a pressing portion 420 and a limit portion 410 connected to the pressing portion 420, the pressing portion 420 is slidable along the second sliding groove 113, and the limit portion 410 is provided with protrusions 411 used for abutting against the clamping plates 210.

In use, the pressing portion 420 is manipulated to move to drive the limit portion 410 to slide in the second sliding groove 113, then the limit portion 410 is arranged between the clamping plates 210, and the protrusions 411 at two ends of the limit portion 410 abut against the two clamping plates 210, such that the minimum relative distance between the clamping plates 210 is limited, the two clamping plates 210 cannot get closer to each other to clamp a mobile phone, and the mobile phone is held merely by the magnetic attraction assembly 300. When the pressing portion 420 is pushed to drive the limit portion 410 to slide on the main body distant from the two clamping plates 210, the minimum relative distance between the clamping plates 210 is no longer limited by the switching component 400, such that a mobile phone can be clamped by the clamping assembly 200. In this way, mode switching of the dual-mode mobile phone holder is achieved.

Preferably, the switching component 400 is T-shaped, wherein the limit portion 410 is a short edge, the pressing portion 420 is a long edge, and one end of the pressing portion 420 protrudes from the main body 110 via the opening of the second sliding groove 113, such that users can easily push the pressing portion 420 to control the position of the limit portion 410.

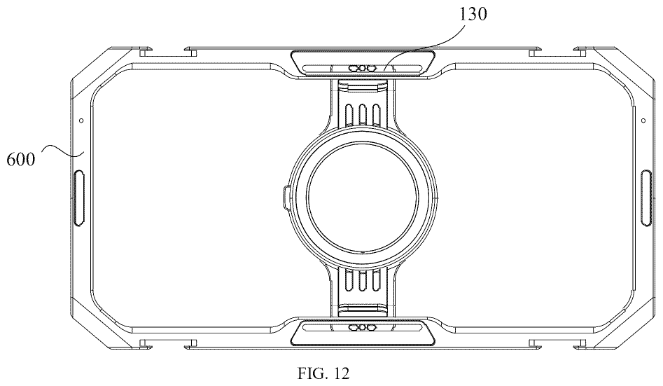

Further, referring to FIGS. 4 and 11, a cover plate 500 is may be arranged above the switching component 400, the cover plate 500 is fixed to the main body 110, an indentation 510 is defined in the bottom of the cover plate 500, and the pressing portion 420 of the switching component 400 penetrates into the indentation 510, such that the switching component 400 is limited between the cover plate 500 and the main body 110 and is prevented from shaking, thus guaranteeing structural stability of the clamping assembly 200 and the magnetic attraction assembly 300.

As shown in FIGS. 4 and 7, in some embodiments, a positioning slot 113a is defined at a stop end of the second sliding groove 113 opposite to the opening, the dual-mode mobile phone holder further comprises a second spring 120 located in the positioning slot 113a, and the limit portion 410 abuts against the second spring 120.

The limit portion 410 is connected to the housing 100 by the second spring 120. One end of the second spring 120 abuts against the positioning slot 113a, and the other end of the second spring 120 abuts against a side face of the limit portion 410, such that the limit portion 410 and the housing 100 are elastically connected, and the positioning slot 113a prevents the second spring 120 against deflection in use. If a user needs to fix a mobile phone only by magnetic attraction, the clamping plates 210 are moved to be farthest away from each other, and at this moment, the limit portions 410 moves to a space between the two clamping plates 210 under the action of an elastic force and abuts against the clamping plates 210, such that a sufficient space is reserved to allow the mobile phone to be placed on the magnetic attraction assembly 300. If a user needs to hold a mobile phone by the clamping plates 210, the pressing portion 420 is pushed to drive the limit portion 410 to move out of the space between the clamping plates 210, and the relative distance between the two clamping plates 210 is adjusted to clamp different types of mobile phones meanwhile. Further, a notch for receiving the second spring 120 is defined at a position of the limit portion 410, corresponding to the positioning slot 113a, to further limit the position of the second spring 120, such that the stability of the second spring 120 is improved.

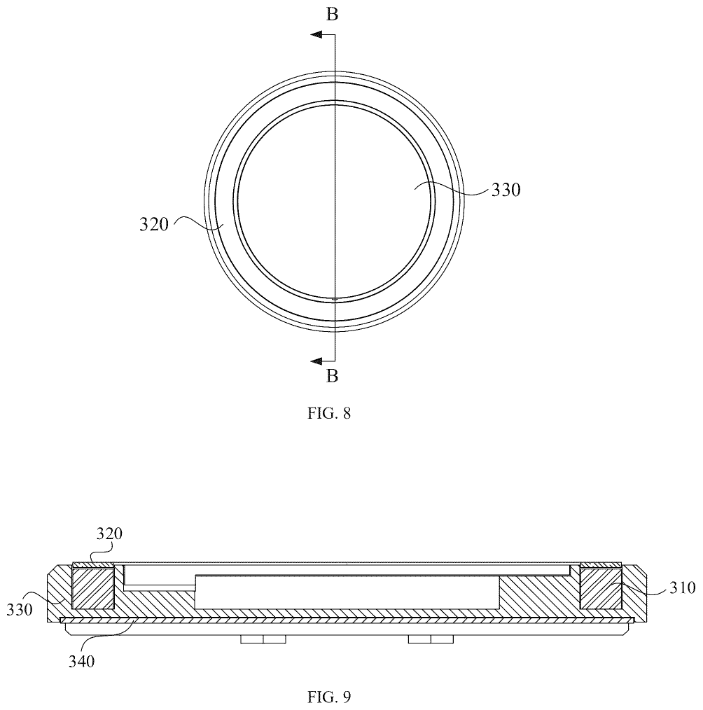

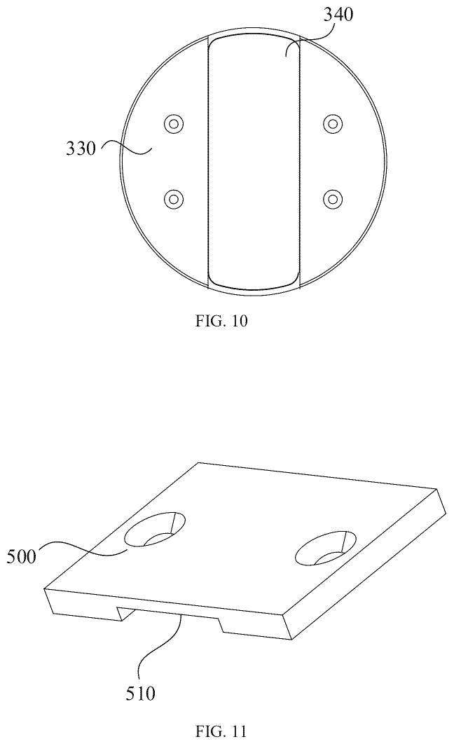

As shown in FIGS. 1, 8, 9 and 10, in some embodiments, the magnetic attraction assembly 300 comprises a magnetic component 310 and a buffer component 320. The magnetic component 310 is connected to the main body 110 and partially covers the sliding portions 211, and the buffer component 320 is arranged around the magnetic component 310.

The magnetic component 310 used for providing a magnetic force to attract a mobile phone, is generally a magnet or an electromagnetic coil, and is generally disposed in the middle of the clamping assembly 200 by bonding. The buffer component 320 covers the magnetic component 310 to prevent the magnetic component 310 against direct contact with a mobile phone when attracting the mobile phone, thus protecting the mobile phone from being scratched and damaged. It can be understood that the buffer component 320 is generally made from an elastic material or a soft material, such as rubber, silicone, fabric or foam to protect the surface of mobile phones.

For example, in one embodiment, the magnetic component 310 is a magnetic ring and covers the sliding portion 211, such that a mobile phone can be fixed in two ways, and the magnetic component 310 can provide a uniform magnetic force in case of a small size to firmly attract the mobile phone onto the dual-mode mobile phone holder. The magnetic component 310 may be formed integrally or by multiple curved magnets that are assembled together to reduce the manufacturing cost. The buffer component 320 is a ring-shaped rubber gasket and covers the magnetic component 310 by bonding. In use, the magnetic component 310 attracts a mobile phone, and the buffer component 320 is sandwiched between the mobile phone and the magnetic component 310, such that the mobile phone is prevented against direct contact with the magnetic component 310 and will not be scratched.

Preferably, the magnetic attraction assembly 300 further comprises a shell 330, the magnetic component 310 is received in the shell 330, and a lubricating sheet 340 is arranged at the bottom of the shell 330 and slidably connected to the sliding portion 211. The shell 330 is used for protecting and receiving the magnetic component 310, and is generally made from plastic, rubber, or other insulating materials. The shell 330 is arranged across the clamping assembly 200 and connected to the housing 100 by bonding, welding or bolts. The lubricating sheet 340 is a structure used for reducing the friction between the clamping plates 210 and the shell 330, and may be made from polytetrafluoroethylene, polyethylene, metal or other common materials with a small surface friction coefficient. Further, to reduce the contact area between the clamping plates 210 and the shell 330, the lubricating sheet 340 should completely cover overlap region between the shell 330 and the clamping plates 210 to ensure that the clamping plates 210 are only in contact with the lubricating sheet 340, thus facilitate sliding of the clamping plates 210 on the housing 100.

Further, the magnetic attraction assembly 300 may further comprise a second magnetic component 350 arranged on a side of the housing 100 facing away from the magnetic component 310, such that both sides of the dual-mode mobile phone holder can attract mobile phones, and two mobile phones can be fixed at the same time, and the application of the dual-mode mobile phone holder is further expanded. Preferably, referring to the above embodiments, a second ring indentation may be defined on a second surface of the housing 100 to receive the second magnetic component 350, and another buffer structure covers the second magnetic component 350 to prevent a mobile phone from being scratched by the second magnetic component 350.

The invention further provides a mobile phone expansion bracket. Referring to FIGS. 3, 7 and 12, in a preferred embodiment, the mobile phone expansion bracket comprises an expansion frame 600 and a dual-mode mobile phone holder. The specific structure of the dual-mode mobile phone holder can be understood with reference to the above embodiments. The mobile phone expansion bracket adopts all the technical solutions in the above embodiments and thus at least has all the technical effects fulfilled by the technical solutions in the above embodiments, which will not be repeated here.

The expansion frame 600, as a frame for expanding the application of mobile phones, generally has a size greater than that of the mobile phones, and the expansion frame 600 is not only used for fixing mobile phones, but also provided with different interfaces and other structures used for connection with other devices. For example, a circular lamp is connected to the expansion frame 600 to assist users in live streaming and other activities by a mobile phone; or, the expansion frame 600 may be connected to other stationary devices, such that a mobile phone can rotate with the expansion frame 600 to adjust the angle of view for adapting to different scenarios and satisfy different requirements, such as watching videos, taking photos, and making video calls.

Mounting plates 130 are generally arranged on opposite sides of the main body 110, and the expansion frame 600 is connected to the dual-mode mobile phone holder in various ways, such as by snap fit, pin connection, magnetic connection, or a plurality of clips arranged on the expansion frame 600. For example, the mounting plates 130 of the dual-mode mobile phone holder are provided with cylindrical protrusions 411 and connecting holes, and recesses and through holes are defined in corresponding positions of the expansion frame 600. The protrusions 411 are fit into the indentations 510 to realize coarse positioning, and bolts penetrate through connecting holes and through holes to fix together the expansion frame 600 and the dual-mode mobile phone holder.

Preferably, threaded holes 131 may be defined in ends of the mounting plates 130 for connection with other devices to expand the application of the dual-mode mobile phone holder. For example, the dual-mode mobile phone holder may be threadedly connected to a tripod, a selfie stick, or other devices, and a mobile phone can be fixed to a suitable position to satisfy different requirements of users. It can be understood that the threaded holes 131 may be replaced with snap-fit or magnetic structures, such that the dual-mode mobile phone holder may be connected to other devices by snap fit or magnetically.

The above embodiments are merely illustrative or preferred ones of the invention, and neither the text description nor the drawings should be construed as limitations of the protection scope of the invention. Based on the concept as the invention, all equivalent structural transformations made according to the description and drawings, or direct/indirection applications to other related fields should fall within the protection scope of the invention.

What is claimed is:

1. A dual-mode mobile phone holder, comprising:
a housing;
a clamping assembly, comprising two clamping plates oppositely arranged on the housing, at least one of the clamping plates being slidable with respect to the housing to clamp or release a mobile phone; and
a magnetic attraction assembly, arranged on the housing and located between the two clamping plates.

2. The dual-mode mobile phone holder according to claim 1, wherein the housing comprises a main body, and the clamping assembly further comprises a first spring, one end of which is connected to the main body and the other end is connected to at least one of the clamping plates.

3. The dual-mode mobile phone holder according to claim 2, further comprising a switching component used for switching between a magnetic attraction mode and a clamping mode of the dual-mode mobile phone holder, wherein in the magnetic attraction mode, the switching component abuts against the clamping plates to keep the two clamping plates away from each other; and in the clamping mode, the switching component keeps away from the clamping plates, and the first spring drives at least one of the clamping plates to allow the two clamping plates to draw close to each other.

4. The dual-mode mobile phone holder according to claim 3, wherein the main body defines a first sliding groove, and the clamping plates are slidably along the first sliding groove; and each of the clamping plates comprises a clamping portion and a sliding portion that is connected to the clamping portion and forms an included angle with the clamping portion, and the sliding portion is slidable along the first sliding groove.

5. The dual-mode mobile phone holder according to claim 4, wherein an elongated hole is defined in each of the sliding portions and extends in a length direction of the corresponding sliding portion, stop pillars are arranged on the main body, and the elongated hole is disposed around the corresponding stop pillar.

6. The dual-mode mobile phone holder according to claim 4, wherein each of the sliding portion is provided with a hooking portion connected to the corresponding first spring.

7. The dual-mode mobile phone holder according to claim 6, wherein the main body defines a second sliding groove, the second sliding groove intersects with the first sliding groove, an opening of the second sliding groove is exposed on the main body; the switching component comprises a pressing portion and a limit portion connected to the pressing portion, the pressing portion is slidable along the second sliding groove, and the limit portion is provided with protrusions used for abutting against the clamping plates.

8. The dual-mode mobile phone holder according to claim 7, wherein a stop end of the second sliding groove is provided with a positioning slot, the dual-mode mobile phone holder further comprises a second spring located in the positioning slot, and the limit portion abuts against the second spring.

9. The dual-mode mobile phone holder according to claim 4, wherein the magnetic attraction assembly comprises a magnetic component and a buffer component, the magnetic component is connected to the main body and partially covers the sliding portions, and the buffer component is arranged around the magnetic component.

10. A mobile phone expansion bracket, comprising an expansion frame and the dual-mode mobile phone holder according to claim 1, wherein the dual-mode mobile phone is provided with mounting plates, and the mounting plates are detachably connected to the expansion frame.

11. A dual-mode mobile phone holder, comprising:
a housing;
a clamping assembly, comprising two clamping plates oppositely disposed on the housing, at least one of the clamping plates being slidable with respect to the housing to adjust a relative distance between the clamping plates for clamping or releasing a mobile phone; and
a magnetic attraction assembly, arranged on the housing and located between the clamping plates for holding a mobile phone by magnetic attraction between the magnetic attraction assembly and the mobile phone.

12. The dual-mode mobile phone holder according to claim 11, comprising a switching component used for switching between a magnetic attraction mode and a clamping mode, wherein the switching component abuts against the clamping plates to increase the relative distance between the clamping plates for disabling holding a mobile phone between the clamping plates in the magnetic attraction mode; and the switching component deviates from the clamping plates for enabling holding a mobile phone between the clamping plates in the clamping mode.

13. The dual-mode mobile phone holder according to claim 12, wherein the housing comprises a main body, the main body defines a first sliding groove and a second sliding groove intersecting with the first sliding groove, at least one of the clamping plates is slidably arranged in the first sliding groove, the switching component comprises a pressing portion and a limit portion connected to the pressing portion, the pressing portion is slidable along the second sliding groove, and the limit portion is provided with protrusions for abutting against the clamping plates.

14. The dual-mode mobile phone holder according to claim 13, wherein one end of the pressing portion protrudes from the main body via an opening of the second sliding groove, for manipulating the pressing portion to drive the limit portion to slide in the second sliding groove, the limit portion is arranged between the clamping plates, and the protrusions are arranged at two ends of the limit portion.

15. The dual-mode mobile phone holder according to claim 14, wherein a positioning slot is defined at a stop end of the second sliding groove opposite to the opening, a second spring is located in the positioning slot, one end of the second spring abuts against the positioning slot, and the other end of the second spring abuts against a side face of the limit portion for elastically connected the limit portion and the housing.

16. The dual-mode mobile phone holder according to claim 11, wherein the magnetic attraction assembly comprises a magnetic component for providing a magnetic force to attract a mobile phone and a buffer component, the magnetic component is a magnet or an electromagnetic coil, and the buffer component covers the magnetic component to prevent the magnetic component against direct contact with a mobile phone.

17. The dual-mode mobile phone holder according to claim 16, wherein the magnetic attraction assembly comprises a second magnetic component arranged on a side of the housing facing away from the magnetic component.

18. The dual-mode mobile phone holder according to claim 11, wherein the housing comprises a main body, the main body defines a first sliding groove, each clamping plate comprises a clamping portion vertically protruding from a top surface of the main body and a sliding portion connected to the clamping portion, the sliding portion is slidable along the first sliding groove, and the depth of the first sliding groove is equal to the thickness of the sliding portion.

19. The dual-mode mobile phone holder according to claim 18, wherein an elongated hole is defined in each of the sliding portions extending in a length direction of the corresponding sliding portion, stop pillars are provided on the main body, the elongated hole is disposed around the corresponding stop pillar, the elongated hole is slidable with respect to the corresponding stop pillar so as to limit a moving direction of the corresponding clamping plate.

20. The dual-mode mobile phone holder according to claim 18, wherein the clamping assembly further comprises at least one first spring, the sliding portion is provided with a hooking portion, one end of the first spring is connected to the main body, and the other end of the first spring is connected to the hooking portion.
